(19) United States
(12) Patent Application Publication
(10) Pub. No.: US 2016/0360193 A1
(43) Pub. Date: Dec. 8, 2016

(54) METHOD OF DIAGNOSING BREAKDOWN OF HEAD UNIT AND CAMERA UNIT FOR VEHICLE

(71) Applicants: Hyundai Motor Company, Seoul (KR); Kia Motors Corporation, Seoul (KR); Hyundai Mobis Co., Ltd., Seoul (KR)

(72) Inventors: Jae Sung Hwang, Seoul (KR); Kyung Yong Park, Yongin (KR)

(21) Appl. No.: 14/948,131

(22) Filed: Nov. 20, 2015

(30) Foreign Application Priority Data
Jun. 5, 2015 (KR) 10-2015-0079782

(51) Int. Cl. H04N 17/00; H04N 5/232; H04N 7/18

(52) U.S. Cl. CPC H04N 17/002; H04N 7/183; H04N 5/23203

(57) ABSTRACT

Disclosed is a method of diagnosing a failure of a head unit and a camera unit for a vehicle including: supplying an operation voltage to the camera unit by the head unit and storing a voltage supply time, when a vehicle gear of the vehicle is located in a set gear stage; storing a signal reception time, when the head unit receives an image signal transmitted by the camera unit; diagnosing whether the camera unit is operating normally based on the voltage supply time and the signal reception time; and storing a breakdown diagnosis result by the head unit, when it is diagnosed that the camera unit breaks down.

### CROSS-REFERENCE TO RELATED APPLICATION

This application claims under 35 U.S.C. §119(a) the benefit of and priority to Korean Patent Application No. 10-2015-0079782 filed on Jun. 5, 2015, the entire contents of which being incorporated herein by reference.

### BACKGROUND

(a) Technical Field

The present disclosure relates generally to a method of diagnosing a breakdown of a head unit and a camera unit for a vehicle. More particularly, the present disclosure relates to a method of diagnosing a failure of a head unit and a camera unit for a vehicle in which the head unit and the camera unit communicate with each other to record a cause of a breakdown of the head unit and the camera unit.

(b) Background Art

In general, a camera for photographing the environment in the rear of a vehicle when the vehicle is driven rearwards is mounted on a rear part of the vehicle, and a head unit including a display is mounted on a center fascia (e.g., center console) panel of the vehicle to show a rear image captured by the rear camera. For reference, the head unit refers to a control unit for collectively managing telematics, a radio set, an audio, a video, and a navigation system.

The rear camera unit (hereinafter, referred to generally as a “camera unit,” though the “camera unit” is not limited to a rear camera unit for the purposes of the present disclosure) for photographing an environment in the rear of the vehicle may include a video amplifier and an image sensor. The head unit may include a display controller (e.g., liquid crystal display (LCD) controller) for controlling the display of an image and a display (e.g., LCD) for actually displaying an image, including a decoder for decoding an image signal and a central processing unit. Accordingly, the head unit and the camera unit mutually identify an image input and an image output, by displaying a rear image captured by the rear camera on a display of the head unit when the vehicle is driven rearwards, so that a driver can easily observe the rear environment while viewing a display screen without turning his or her head rearwards.

However, the camera unit and the head unit independently diagnose a breakdown through self-diagnoses. That is, in order for the camera unit and the head unit to perform self-diagnoses, the camera unit identifies only self-information recorded in an electronic control unit (ECU) for a rear camera, while the head unit identifies only self-information recorded in an ECU for the head unit. As a result, the technology has the following problems.

First, when a power supply problem for the camera unit occurs, it is difficult to find an accurate cause of a breakdown because the breakdown is recorded only by the camera unit. For example, the breakdown record is left only in the ECU of the camera unit even though the rear camera has no error. When the breakdown record is not left in the ECU for the head unit, it is difficult to accurately recognize whether the head unit or the camera unit breaks down.

Second, even if an image input breakdown of the camera is recorded only in the ECU for the head unit, it is difficult to find an accurate cause of a breakdown. That is, although the camera unit normally transmits an image, when an image input breakdown of the camera is recorded in the ECU for the head unit, a breakdown of the screen of the head unit can slowly occur (e.g., audio-video-navigation (AVN) data is processed and a loss is generated in a cable). Accordingly, it may be difficult to accurately recognize whether the head unit or the rear camera has broken down.

In this way, because a breakdown of the camera unit and/or the head unit cannot be accurately identified, it cannot be recognized whether the head unit or the camera unit breaks down, causing maintenance service and time to be unnecessarily consumed.

### SUMMARY OF THE DISCLOSURE

The present disclosure has been made in an effort to solve the above-mentioned problems, and a method of diagnosing a failure of a head unit and a camera unit for a vehicle in which the head unit and the camera unit communicate with each other to record a cause of a breakdown of the head unit and the camera unit while mutually diagnosing and checking a breakdown of the head unit and the camera unit, such that which of a head unit and a camera unit breaks down may be precisely determined.

In accordance with embodiments of the present disclosure, there is provided a method of diagnosing a breakdown of a head unit and a camera unit for a vehicle, the method including: supplying an operation voltage to the camera unit by the head unit and storing a voltage supply time, when a vehicle gear of the vehicle is located in a set gear stage; storing a signal reception time, when the head unit receives an image signal transmitted by the camera unit; diagnosing whether the camera unit is operating normally based on the voltage supply time and the signal reception time; and storing a breakdown diagnosis result by the head unit, when it is diagnosed that the camera unit breaks down.

The method may further include: diagnosing whether the camera unit is operating normally; calculating a time difference between the voltage supply time and the signal reception time; determining whether the calculated time difference is within a preset reference time range; determining that the camera unit is operating normally, when the calculated time difference is within the preset reference time range; and determining that the camera unit breaks down, when the calculated time difference is not within the preset reference time range.

The reference time range may be set to 1.5 to 3 seconds.

The breakdown diagnosis result stored by the head unit may include at least one of a booting error of the camera unit and a signal level error of the image signal.

The method may further include: transmitting a time difference request signal to the head unit after the camera unit transmits the image signal; and receiving a time difference response signal including a time difference between the voltage supply time and the signal reception time by the camera unit.

The method may further include: self-diagnosing a time difference between the voltage supply time and the signal reception time based on the time difference by the camera unit after receiving the time difference response signal; and storing breakdown information, when it is determined that the camera unit breaks down.

The method may further include: displaying an image corresponding to the image signal by the head unit after storing the signal reception time.

The method may further include: transmitting a breakdown request signal that requests a previous breakdown diagnosis result stored in advance to the head unit by the camera unit after the image is displayed; and transmitting the breakdown response signal including the previous breakdown diagnosis result to the camera unit when the head unit receives the breakdown request signal and when the previous breakdown diagnosis result for the camera unit is stored.

The method may further include: storing the previous breakdown diagnosis result included in the breakdown response signal, when the camera unit receives the breakdown response signal.

The method may further include: determining that the head unit breaks down and storing breakdown information of the head unit, when the camera unit does not receive a breakdown response signal within a preset time interval.

Accordingly, when a vehicle gear is located in a preset stage (i.e., a rearward stage), a camera unit and a head unit mutually diagnose a breakdown and mutually store a diagnosis result, based on a signal transmitted to and received from the same interface between the camera unit and the head unit that interlock each other, so that a cause of a breakdown of the camera unit or the head unit based on the stored breakdown information may be easily found. As a result, convenience of the user and maintenance service quality may be improved.

### BRIEF DESCRIPTION OF THE DRAWINGS

The above and other features of the present disclosure will now be described in detail with reference to certain embodiments thereof illustrated the accompanying drawings which are given hereinbelow by way of illustration only, and thus are not limitative of the present disclosure, and wherein:

FIG. 1 is a control block diagram illustrating a control configuration for diagnosing a breakdown of a head unit and a camera unit for a vehicle according to embodiments of the present disclosure; and

FIG. 2 is a control sequence diagram illustrating a method of diagnosing a breakdown of a head unit and a camera unit for a vehicle according to embodiments the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

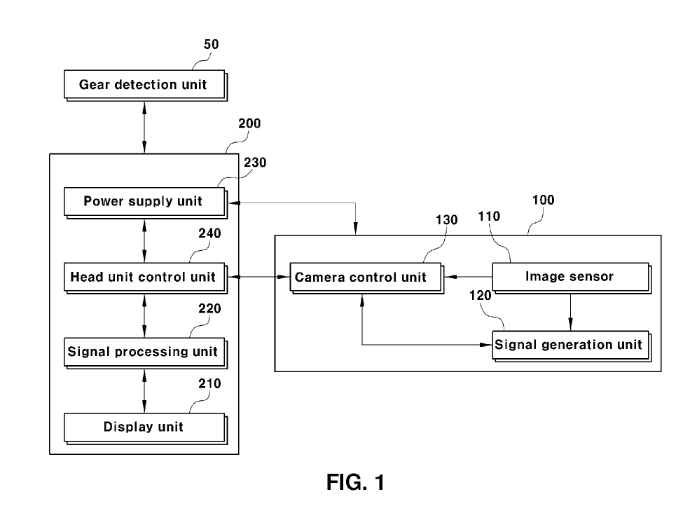

Referring now to the disclosed embodiments, FIG. 1 is a control block diagram schematically illustrating a control configuration of a head unit and a camera unit for a vehicle.

FIG. 1 illustrates the control configuration of the camera unit 100 and the head unit 200, among various components installed in the vehicle, which are associated with each other when the vehicle is driven rearwards and parked, but the present disclosure is not limited thereto.

As shown in FIG. 1, the control configuration for diagnosing a breakdown of the head unit and the camera unit for a vehicle includes a gear detection unit 50, a camera unit 100, and a head unit 200.

The gear detection unit 50 detects whether the vehicle gear is located in a set gear stage (e.g., a rearward R-stage). That is, when the vehicle gear is located in the rearward R-stage, the gear detection unit 50 transmits to the head unit 200 that the current gear stage is a rearward gear stage.

The camera unit 100 includes an image sensor 110, a signal generating unit 120, and a camera control unit 130.

The image sensor 110 captures an image for a periphery (e.g., rear side, front side, right side, left side, etc.) of the vehicle under the control of the camera control unit 130, and the signal generating unit 120 generates an image signal corresponding to the image captured by the image sensor 110 under the control of the camera control unit 130 and transmits the image signal to the head unit 200.

When an operation voltage V is supplied from the head unit 200, the camera control unit 130 activates the image sensor 110 and the signal generating unit 120 to make a control to transmit the image signal to the head unit 200. After the image signal is transmitted, the camera control unit 130 transmits a time difference request signal to the head unit 200, receives a time difference response signal from the head unit 200, performs a self-diagnosis to identify a breakdown of the camera control unit, and stores a self-diagnosis result.

Then, when the time difference included in the time difference response signal belongs to a set reference time range, the camera control unit 130 self-diagnoses that the camera unit 100 is operating normally, and when the time difference included in the time difference response signal does not belong to the reference time range, the camera control unit 130 self-diagnoses that the camera unit 100 breaks down (i.e., abnormally operated) and stores the self-diagnosis result.

The camera control unit 130 receives a booting completion signal from the head 200, transmits a breakdown request signal to the head unit 200 at a set time interval after an image for the image signal is displayed in the head unit 200, and receives a breakdown response signal transmitted from the head unit 200. Here, when a breakdown response signal is not received at a set time interval, the camera control unit 130 identifies that the head unit 200 breaks down and stores breakdown information of the head unit 200. When a prior breakdown diagnosis result previously stored for the camera unit 100 is included in the breakdown response signal, the camera control unit 130 stores a previous breakdown diagnosis result, and otherwise, the camera control unit 130 determines that the camera unit 100 is normally operating.

The head unit 200 includes a display unit 210, a signal processing unit 220, a power supply unit 230, and a head unit control unit 240.

The display unit 210 is mounted on a center fascia (e.g., center console) panel of the vehicle to display a rear image corresponding to an image signal transmitted by the camera unit 100.

The signal processing unit 220 signal-processes an image signal from the camera unit, and removes a noise component included in the image signal, restores the original image, and transmits an image signal such that an image is displayed on the display unit 210.

The power supply unit 230 generates an operation voltage supplied to the camera unit 100 under the control of the head unit control unit 240, and the power supply unit 230 may include a power supply but the present disclosure is not limited thereto. When it is determined from a signal of the gear detection unit 50 that the vehicle gear is located in a set gear stage (e.g., rearward gear stage), the head unit control unit 240 controls the power supply unit 230 to control the camera unit 100 such that the operation voltage is supplied to the camera unit 100. Then, the head unit control unit 240 stores a power supply time when an operation voltage is supplied to the camera unit 100.

Thereafter, the head unit control unit 240 receives the image signal transmitted as the camera unit 100 is booted, and stores a signal reception time. The head unit control unit 240 calculates a time difference between the power supply time and the signal reception time and determines whether the time difference belongs to a set reference time range. Here, when the calculated time difference belongs to the reference time range, the head unit control unit 240 diagnoses that the camera unit 100 is normally operated, and otherwise, the head unit control unit 240 diagnoses that the camera unit 100 is abnormally operated.

Then, the reference time range is a time range where an image signal is transmitted as the camera unit 100 is operated according to an operation voltage supplied to the camera unit 100, and is a time range set according to experiment and may be 1.5 to 3 seconds, as an example. When it is diagnosed that the camera unit 100 breaks down, the head unit control unit 240 may store a breakdown diagnosis result including at least one of a booting error of the camera unit 100 and a signal level error of the image signal but the present disclosure is not limited thereto. When receiving a breakdown request signal transmitted from the camera unit 100 after the image is displayed on the display unit 210, the head unit control unit 240 transmits a breakdown response signal corresponding to the breakdown request signal to the camera unit 100. That is, when receiving a breakdown request signal from the camera unit 100, the head unit control unit 240 transmits a breakdown response signal including a previous breakdown diagnosis result stored when the camera unit 100 breaks down.

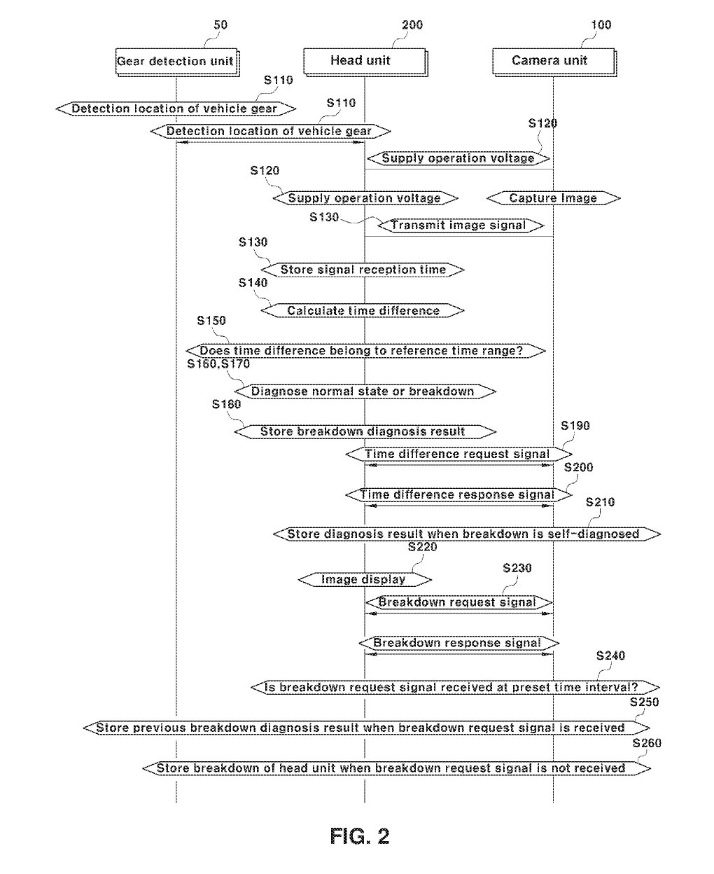

This way, the breakdown diagnosis system according to the present disclosure provides an advantage of sharing breakdown information generated by the camera unit 100 and the head unit 200 which interwork with each other. In this regard, embodiments of a method of diagnosing a breakdown of a head unit and a camera unit for a vehicle according to the present disclosure will be described below in detail with reference to FIG. 2.

FIG. 2 is a flowchart illustrating a method of diagnosing a breakdown for the breakdown diagnosis system of the vehicle illustrated in FIG. 1.

First, the gear detection unit 50 detects whether the vehicle gear is located in a set gear stage (rearward gear stage) (S110).

Thereafter, when the vehicle gear is located in the rearward gear stage, the head unit 200 supplies an operation voltage to the camera unit 100 and stores a power supply time (S120), and the camera unit 100 captures a rear image of the vehicle according to supply of a power voltage and the head unit 200 stores a signal reception time if receiving an image signal (e.g., a rear image capturing signal of the vehicle) transmitted from the camera unit 100 (S130).

Thereafter, the head unit 200 calculates a time difference between a voltage supply time for the camera unit 100 and a signal reception time when an image signal is received from the camera unit 100 (S140), and determines whether the time difference belongs to a set reference time range (S150).

Subsequently, when the calculated time difference belongs to the reference time range, the head unit 200 diagnoses that the camera unit 100 is normally operated (S160), and otherwise, the head unit 200 diagnoses the camera unit 100 breaks down (S170) and stores a breakdown diagnosis result when it is diagnosed that the camera unit 100 breaks down (S180).

Next, the camera unit 100 transmits a time difference request signal that requests the time difference calculated for the head unit 200 (S190), and receives a time difference response signal including a time difference from the head unit 200 (S200).

Subsequently, the camera unit 100 performs a self-diagnosis based on the time difference included in the time difference response signal, and when it is self-diagnosed that the camera unit 100 breaks down, the camera unit 100 stores self-diagnosis information (S210).

Meanwhile, the head unit 200 displays an image corresponding to the image signal received from the camera unit 100 in S130 (S220). Accordingly, when the vehicle is moved rearwards, the drive can view a rear image through the display included in the head unit 200.

The camera unit 100 then transmits a breakdown request signal that requests a previous breakdown diagnosis result for the camera unit 100 to the head unit 200 (S230). Therefore, when the head unit 200 transmits a breakdown response signal to the camera unit 100, the camera unit 100 determines whether a breakdown response signal corresponding to the breakdown request signal is received from the head unit 200 at the set time interval (S240).

Then, when receiving a breakdown response signal at a set time interval, the camera unit 100 stores a previous breakdown diagnosis result included in the breakdown response signal (S250).

Meanwhile, if a breakdown response signal is not received at a set time interval, the camera unit 100 identifies that the head unit 200 breaks down and stores breakdown information of the head unit 200 (S260).

As mentioned above, in the method of diagnosing a breakdown of a head unit and a camera unit for a vehicle according to the present disclosure, the camera unit 100 and the head unit 200 may communicate with each other through the same interface, may mutually share breakdown stored information according to their signals, and may mutually perform a breakdown diagnosis.

Although embodiments of the present disclosure have been illustrated and described, the present disclosure is not limited to the specific embodiment, but it will be noted that the present disclosure may be variously modified by those skilled in the art without departing from the spirit of the present disclosure and the modifications should not be individually understood from the spirt and range of the present disclosure.

What is claimed is:

1. A method of diagnosing a breakdown of a head unit and a camera unit for a vehicle, the method comprising:
supplying an operation voltage to the camera unit by the head unit and storing a voltage supply time, when a vehicle gear of the vehicle is located in a set gear stage;
storing a signal reception time, when the head unit receives an image signal transmitted by the camera unit;
diagnosing whether the camera unit is operating normally based on the voltage supply time and the signal reception time; and
storing a breakdown diagnosis result by the head unit, when it is diagnosed that the camera unit breaks down.

2. The method of claim 1, further comprising:
diagnosing whether the camera unit is operating normally; calculating a time difference between the voltage supply time and the signal reception time;
determining whether the calculated time difference is within a preset reference time range;
determining that the camera unit is operating normally, when the calculated time difference is within the preset reference time range; and
determining that the camera unit breaks down, when the calculated time difference is not within the preset reference time range.

3. The method of claim 2, wherein the reference time range is set to 1.5 to 3 seconds.

4. The method of claim 1, wherein the breakdown diagnosis result stored by the head unit includes at least one of a booting error of the camera unit and a signal level error of the image signal.

5. The method of claim 1, further comprising:
transmitting a time difference request signal to the head unit after the camera unit transmits the image signal; and
receiving a time difference response signal including a time difference between the voltage supply time and the signal reception time by the camera unit.

6. The method of claim 5, further comprising:
self-diagnosing a time difference between the voltage supply time and the signal reception time based on the time difference by the camera unit after receiving the time difference response signal; and
storing breakdown information, when it is determined that the camera unit breaks down.

7. The method of claim 1, further comprising:
displaying an image corresponding to the image signal by the head unit after storing the signal reception time.

8. The method of claim 7, further comprising:
transmitting a breakdown request signal that requests a previous breakdown diagnosis result stored in advance to the head unit by the camera unit after the image is displayed; and
transmitting the breakdown response signal including the previous breakdown diagnosis result to the camera unit when the head unit receives the breakdown request signal and when the previous breakdown diagnosis result for the camera unit is stored.

9. The method of claim 8, further comprising:
storing the previous breakdown diagnosis result included in the breakdown response signal, when the camera unit receives the breakdown response signal.

10. The method of claim 8, further comprising:
determining that the head unit breaks down and storing breakdown information of the head unit, when the camera unit does not receive a breakdown response signal within a preset time interval.
